(19) United States
(12) Patent Application Publication
(10) Pub. No.: US 2021/0189707 A1
(43) Pub. Date: Jun. 24, 2021

(54) GARBAGE DISPOSAL WITH DOOR AND SWITCH ASSEMBLY

(71) Applicant: Susan E. Wright, Dallas, TX (US)

(72) Inventor: Susan E. Wright, Dallas, TX (US)

(21) Appl. No.: 17/127,919

(22) Filed: Dec. 18, 2020

Related U.S. Application Data
(60) Provisional application No. 62/949,760, filed on Dec. 18, 2019.

(51) Int. Cl. E03C 1/266; B02C 18/00; B02C 18/22; B02C 23/20; B02C 23/36

(52) U.S. Cl. CPC E03C 1/2665; B02C 18/0092; B02C 23/36; B02C 23/20; B02C 18/2216

(57) ABSTRACT

A garbage disposal assembly includes a garbage disposal and switch assembly. Each may be independent of the other in operation. The disposal assembly includes a housing with an opening for passage of particulates into an interior volume. A motor is located within the housing. A flywheel and impellers break up the particulates. An access door permits access into the interior volume separate from that of the opening at the sink. The switch assembly has a switch housing with a dial and a switch. Power to the switch is regulated by the dial which pulses a single amount of power through the switch when the switch is activated. The switch rests in a neutral position allowing a single contact by a user to activate and deactivate an electronic device coupled to the switch assembly.

### CROSS REFERENCE TO RELATED APPLICATIONS

This application claims the benefit of an earlier filing date and right of priority to U.S. Provisional Application No. 62/949,760, filed 18 Dec. 2019, the contents of which is incorporated by reference herein in its entirety.

### BACKGROUND OF THE INVENTION

### 1. Field of the Invention

The present application relates to a garbage disposal and switch assembly, and more particularly to a garbage disposal having an operable door to reach within the interior of the disposal from cleaning as well as a switch for governing power supplied to the disposal.

### 2. Description of Related Art

Washing dishes is a part of everyday life for most individuals. When a person is washing dishes or merely scraping dishes to put in a dishwasher, the sink often fills up with some water and large food particulates. The particulates act to clog the sink and back the water up. These particulates may either be scooped up with the hand or a tool and transferred to a trash receptacle, or may be passed down a garbage disposal connected to the sink.

The act of carrying the particulates to the trash receptacle can be messy. Therefore, a number of individuals use a disposal. Currently a switch is used to regulate power to the disposal. The switch operates between an off and on position. When needed, an individual flicks the switch and power is provided to the disposal. The disposal continues to run until the switch is turned off. As the process of using the disposal is not relatively long, the individual tends to keep their hand on the switch waiting to turn it off. The disadvantage here is that the hands are typically not clean and water tends to drip down the switch and switch plate or onto the counter. Additionally, scrap particulates can be transferred to the switch and make it unsightly. Alternatively, the individual may turn the switch on and return to scraping dishes only then to return to the switch to turn it off moments later.

Garbage disposals are common kitchen devices used to aid in the disposing of food particulates. As dishes are cleaned in a sink, food particles may be left on the plate and eventually collect in the sink after rinsing or washing. The food particles may be rinsed down the drain if small enough. In an effort to minimize the chances of clogging in the wastewater drain, a garbage disposal is often attached to an underside of the sink. The food particles travel through the disposal where the impellers break up the particles into smaller sized pieces to permit easier flow through the drain.

It sometimes occurs where the disposal clogs and needs to be cleaned out. Currently a user must either stick their hand or an implement down through the sink opening to try and reach around the internal compartment of the disposal to clear away the clog. This is difficult to do as the sink opening is small and there is minimal visibility. This can also result in minimal to severe stress to the user because of the dirty nature of a disposal and the blades that can be felt but not seen. Another option is to remove the disposal from the sink. This is not ideal as it is often heavy and is connected to a waste line. Water inevitably leaks and a user is still left with the only option of sticking their hand or an implement through the opening of the garbage disposal which is the same size as the opening of the sink. Visibility is minimal.

Although strides have been made with respect to garbage disposals and switches, shortcomings remain. It is desired that an assembly be provided that is configured to permit easier accessibility to the interior of the disposal and a more convenient method of regulating disposal operation.

### BRIEF SUMMARY OF THE INVENTION

It is an object of the present application to provide a garbage disposal that includes a side access door in the housing for the ability to enter the interior volume for the maintenance of the disposal. Additionally, a switch assembly is provided to regulate operation of the disposal, or any associated electrical device, so as to eliminate the need to maintain control of a switch while the disposal is in use or to return to the switch multiple times to turn it on and off. The garbage disposal assembly and the switch assembly may be used individually or combined together.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is an exploded perspective view of a garbage disposal assembly according to an embodiment of the present application.

FIG. 2 is a perspective view of a switch assembly according to an embodiment of the present application.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

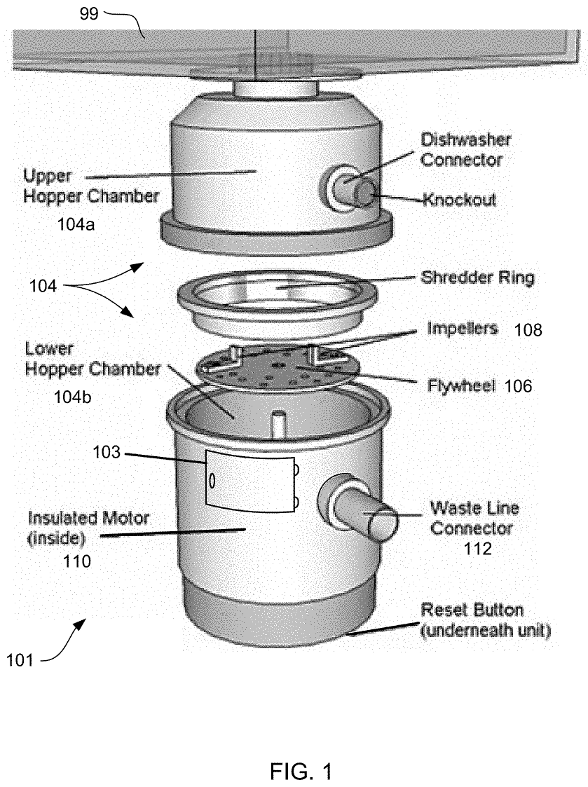

Referring now to FIG. 1 in the drawings, a garbage disposal system 101 is illustrated. The garbage disposal assembly 101 of the present application is configured to permit access to the interior of the garbage disposal through an alternate access location from the side of a housing 104. The housing includes upper hopper chamber 104a and lower hopper chamber 104b.

Assembly 101 further includes flywheel 106 and impellers 108 which rotate within an interior volume of housing 104. As food and particulates pass through sink 99 and into the interior volume, motor 110 is selectively activated by a user which initiates flywheel 106 and impellers 108. Motor 110 is located in the lower chamber. These are initiated to impale and break up the particulates/food to sizes small enough to pass through waste line connector 112 and down the drain lines.

The flywheel is located adjacent an internal surface in lower chamber 104b such that the interior volume is predominantly above the flywheel 106 and impellers 108. The disposal is located in contact with an underside of a sink 99 wherein the sink hole aligns with a hole in the neck of the upper chamber 104a.

Access door 103 is configured to selectively open and close to permit access into the interior volume. This is useful to clear obstructions to avoid the need to detach the disposal from the sink to gain better access.

In operation, food particulates or other matter is passed down through the hole in the upper chamber body into the interior volume where they come into contact with the flywheel and impellers. Water is usually passed with the particulates in an effort to assist in carrying them through the flywheel and out a waste line to the drain. During operation, the motor is turned on such that the impellers and flywheel rotate so as to pulverize the particulates in an effort to decrease their size to make passage through the waste line feasible.

Disposal 101 includes a side access auxiliary door 103 to permit access into the internal volume of the disposal body. Particulates can become stuck causing clogs in the disposal during operation. To alleviate the need to remove the disposal to clear the clog, or the need to frustratingly jam implements or hands down the opening of the disposal 101, access door 103 is operable between an open and a closed position to selectively permit side access into the interior to remove the clog.

An advantage of door 103 is that there are now two access locations to the interior. Where only one was available, efforts to insert a hand or tool into the opening blocked the ability to shine a light to allow visibility into the interior. With two access points, a light can be shown through one hole while a tool or hand can be inserted into the other. Visibility inside is now possible. Additionally, a side access provides a user better access and sight within the interior to see and function. Clogs can be removed faster and more conveniently.

It is understood that door 103 may be located around the perimeter of the disposal body at any area. The size and shape of door 103 may be modified or selected in accordance with design criteria. Door 103 is also sealed in contact with housing 104 to prevent leakage.

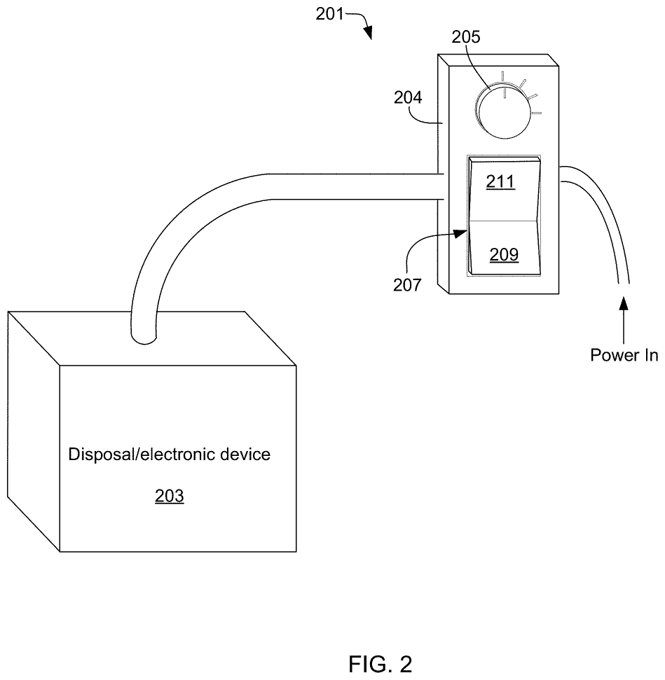

Referring now also to FIG. 2 in the drawings, a perspective view of a switch assembly 201 is illustrated. The switch assembly of the present application is configured to provide selective preset control of an electrical device in a manner that automatically limits the run time of the device and does not require a user to have to manually maintain control of the switch while the device is running or through manual operation of a control (dial/switch) in alternate directions. As noted above, the switch assembly is operable with a garbage disposal coupled to a sink. However, the switch assembly is not so limited in its use and the description of the disposal is merely exemplary in nature as the functions and features of the switch assembly are applicable to any electrical device.

Switch assembly 201 is in communication with an electronic device 203. An example of device 203 may be a garbage disposal 101, but other electronic devices are contemplated. Switch assembly 201 is configured to receive electrical power and route that power so as to operate with a dial 205 and a switch 207. Dial 205 and switch 207 are in electrical communication with each other so as to allow dial 205 to selectively affect the performance of switch 207. Dial 205 and switch 207 are located within a housing 204.

As a whole, assembly 201 is configured to regulate the transmission of power to device 203. Device 203 is configured to run when power is received. Assembly 201 selectively restricts power from reaching device 203. Switch 207 is configured to remain at rest in a neutral position wherein electrical power is not permitted to flow to device 203. When depressed or operated, switch 207 is configured to allow power to flow to device 203 for a limited preset duration. A single contact with the switch provides an intermittent amount of electric power to pass to device 203. This duration may be preset upon manufacture. The duration may be determined based upon the device it is operating.

In FIG. 2, switch 207 is a toggle switch or rocker switch. In this style, a user may elect to push a lower section 209 or an upper section 211. The selection and subsequent operation of each section 209/211 allows power to flow to device 203 for a limited time. Section 209 is used to provide the preset duration noted above. Section 211 is used to allow an operator to provide power for a user selected time duration. With both sections 209/211 the user merely has to push the particular section to activate and the switch 207 will return to the neutral setting. This negates the need of the user to have to keep a hand on the switch to manually turn it off or to have to return to the switch a second time to turn it off.

Dial 205 is a control device which is not herein limited to a round or cylindrical rotating control. Dial 205 is configured to regulate the time duration of upper section 211. A user may rotate or operate dial 205 to different durations of time. This may be set once or multiple times. Upper section 211 operates to whatever the time duration of dial 205 is set to.

In the example of device 203 being a garbage disposal, the functional operation of switch assembly 201 can be shown. When at a sink, a user may need to activate the disposal. The user may elect to push section 209 wherein the manufacture preset time duration governs the length of time the disposal runs. This time can be chosen to be any length but for this purpose, perhaps a length of 1 second is best. The user only has to punch or depress section 209 and then immediately remove his/her hand. By being a depressible switch, the user may use any portion of the body or an object to initiate the depression. By not having to use a dirty hand, or by not having to leave their hand on a switch or return to it to turn it off, the environment around switch assembly 201 remains cleaner.

Alternatively, a user may elect to select section 211 wherein the time duration is governed by dial 205. Prior to initiation of section 211, a user can optionally adjust dial 205 wherein an alternative time duration compared to section 209 may be chosen. Initiation of section 211 will run for the duration selected on dial 205. The disposal may optionally run for anywhere between 5 and 30 seconds perhaps. Longer times are possible.

It is understood that switch 207 may be composed of one or more independently operable switches and is not herein limited to the type depicted. Furthermore, any manner of switch operation is permitted (i.e. flick switch) but it is preferred that the switch return immediately to a neutral position automatically to avoid the need to manually turn it off and the need to keep a dirty hand on the switch or to return to the switch.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A garbage disposal assembly, comprising:
a housing including an opening for passage of particulates into an interior volume;
a motor within the housing;
a flywheel in communication with the motor, the motor selectively initiating rotation of the flywheel;
an impeller coupled to the flywheel to break up the particulates;
wherein the housing includes an access door to permit access into the interior volume separate from that of the opening.

2. The assembly of claim 1, wherein the housing includes a reset button to control power to the motor.

3. The assembly of claim 1, wherein the access door is sealed against the housing to prevent leakage.

4. The assembly of claim 1, further comprising:
a waste line connector in communication with the interior volume.

5. The assembly of claim 1, further comprising:
a switch assembly in communication with the motor, the switch assembly including a control being either a dial or switch to selectively regulate activation of the motor.

6. A switch assembly, comprising:
a housing;
a switch within the housing operable between two positions; and
a dial within the housing configured to selectively regulate a duration of power applied through the switch when the switch is activated.

7. The assembly of claim 6, wherein the dial is adjustable so as to adjust the duration of power passed to the switch.

8. The assembly of claim 6, wherein a single contact with the switch provides an intermittent amount of electric power to pass to a device.

9. The assembly of claim 6, wherein the switch remains in a neutral position as rest.

10. The assembly of claim 6, wherein the duration is adjustable.

11. The assembly of claim 6, further comprising:
an electronic device configured to receive power from the switch.

12. A garbage disposal assembly, comprising:
a housing including an opening for passage of particulates into an interior volume;
a motor within the housing;
a flywheel in communication with the motor, the motor selectively initiating rotation of the flywheel;
an impeller coupled to the flywheel to break up the particulates;
wherein the housing includes an access door to permit access into the interior volume separate from that of the opening;
a switch housing;
a switch within the switch housing operable between two positions; and
a dial within the housing configured to selectively regulate a duration of power applied through the switch when the switch is activated.
